(19) United States
(12) Patent Application Publication
(10) Pub. No.: US 2024/0370796 A1
(43) Pub. Date: Nov. 7, 2024

(54) MACHINE LEARNING-BASED PRODUCTION OPTIMIZERS

(71) Applicant: C3.ai, Inc., Redwood City, CA (US)

(72) Inventors: Nevroz Sen, San Jose, CA (US); Zhaoyang Jin, Newark, CA (US); Mehdi Maasoumy Haghighi, Redwood City, CA (US); Yunxuan Jiang, Redwood City, CA (US); Fabian Rigterink, Redwood City, CA (US); Brett Stewart, La Grange Park, IL (US); Suman Tripathy, Pleasanton, CA (US)

(21) Appl. No.: 18/654,876

(22) Filed: May 3, 2024

Related U.S. Application Data
(60) Provisional application No. 63/499,952, filed on May 3, 2023.

(51) Int. Cl. G06Q 10/0631; G06Q 50/02

(52) U.S. Cl. CPC G06Q 10/06312; G06Q 50/02

(57) ABSTRACT

A method includes obtaining, using at least one processing device, data from one or more data sources, where the data is associated with or affects an underlying system to be optimized. The method also includes generating, using the at least one processing device, predictions based on the obtained data, where the predictions represent estimated values associated with one or more time-varying parameters associated with the underlying system. The method further includes providing, using the at least one processing device, the predictions to an optimizer. In addition, the method includes executing, using the at least one processing device, the optimizer to generate optimization results based on the predictions, where the optimization results are associated with the underlying system.

### CROSS-REFERENCE TO RELATED APPLICATION AND PRIORITY CLAIM

This application claims priority under 35 U.S.C. § 119 (e) to U.S. Provisional Patent Application No. 63/499,952 filed on May 3, 2023, which is hereby incorporated by reference in its entirety.

### TECHNICAL FIELD

This disclosure is generally directed to machine learning-based systems and other prediction systems. More specifically, this disclosure is directed to machine learning-based approaches and other approaches for generating inputs for optimizers.

### BACKGROUND

One issue commonly experienced in agriculture harvesting involves the maximization of total goods that can be extracted from harvested raw crops, typically while minimizing total transportation costs and satisfying constraints like (i) assuring that certain fields are only harvested manually or mechanically and (ii) not producing and transporting more harvested crops than downstream processing capacity can handle. Moreover, harvesting can be affected by a number of unpredictable factors, such as weather and other environmental conditions and community behaviors (like theft). This becomes particularly challenging since the total amount of goods that can be extracted from raw crops is time-varying and since the raw crops can be subject to degradation over time. A specific example of this involves the extraction of sucrose from raw sugar cane, where the amount of sucrose extracted can vary based on (i) the state of the raw sugar cane at the time of harvesting and (ii) the amount of time between harvesting and processing. These types of challenges can be observed in other domains, as well, such as during the maximization of power output from steam engines or during the optimization of chemical processes.

### SUMMARY

This disclosure relates to machine learning-based approaches and other approaches for generating inputs for optimizers.

In a first embodiment, a method includes obtaining, using at least one processing device, data from one or more data sources, where the data is associated with or affects an underlying system to be optimized. The method also includes generating, using the at least one processing device, predictions based on the obtained data, where the predictions represent estimated values associated with one or more time-varying parameters associated with the underlying system. The method further includes providing, using the at least one processing device, the predictions to an optimizer. In addition, the method includes executing, using the at least one processing device, the optimizer to generate optimization results based on the predictions, where the optimization results are associated with the underlying system.

In a second embodiment, an apparatus includes at least one processing device configured to obtain data from one or more data sources, where the data is associated with or affects an underlying system to be optimized. The at least one processing device is also configured to generate predictions based on the obtained data, where the predictions represent estimated values associated with one or more time-varying parameters associated with the underlying system. The at least one processing device is further configured to provide the predictions to an optimizer and execute the optimizer to generate optimization results based on the predictions, where the optimization results are associated with the underlying system.

In a third embodiment, a non-transitory computer readable medium stores computer readable program code that, when executed by one or more processors, causes the one or more processors to obtain data from one or more data sources, where the data is associated with or affects an underlying system to be optimized. The non-transitory computer readable medium also stores computer readable program code that, when executed by the one or more processors, causes the one or more processors to generate predictions based on the obtained data, where the predictions represent estimated values associated with one or more time-varying parameters associated with the underlying system. The non-transitory computer readable medium further stores computer readable program code that, when executed by the one or more processors, causes the one or more processors to provide the predictions to an optimizer and execute the optimizer to generate optimization results based on the predictions, where the optimization results are associated with the underlying system.

Other technical features may be readily apparent to one skilled in the art from the following figures, descriptions, and claims.

### BRIEF DESCRIPTION OF THE DRAWINGS

For a more complete understanding of this disclosure, reference is now made to the following description, taken in conjunction with the accompanying drawings, in which:

FIG. 1 illustrates an example system supporting a machine learning-based approach or other approach for generating inputs for an optimizer according to this disclosure;

FIG. 2 illustrates an example device supporting a machine learning-based approach or other approach for generating inputs for an optimizer according to this disclosure;

FIG. 3 illustrates an example environment in which a machine learning-based approach or other approach for generating inputs for an optimizer can be used according to this disclosure;

FIG. 4 illustrates an example machine learning-based approach or other approach for generating inputs for an optimizer according to this disclosure;

FIG. 5 illustrates an example iterative process in which a machine learning-based approach or other approach for generating inputs for an optimizer can be used according to this disclosure;

FIG. 6 illustrates an example type of schedule that could be generated using a machine learning-based approach or other approach for generating inputs for an optimizer according to this disclosure;

FIG. 7 illustrates an example process for using a machine learning-based approach or other approach for generating inputs for an optimizer according to this disclosure; and

FIG. 8 illustrates an example method for generating inputs for an optimizer using a machine learning-based approach or other approach according to this disclosure.

### DETAILED DESCRIPTION

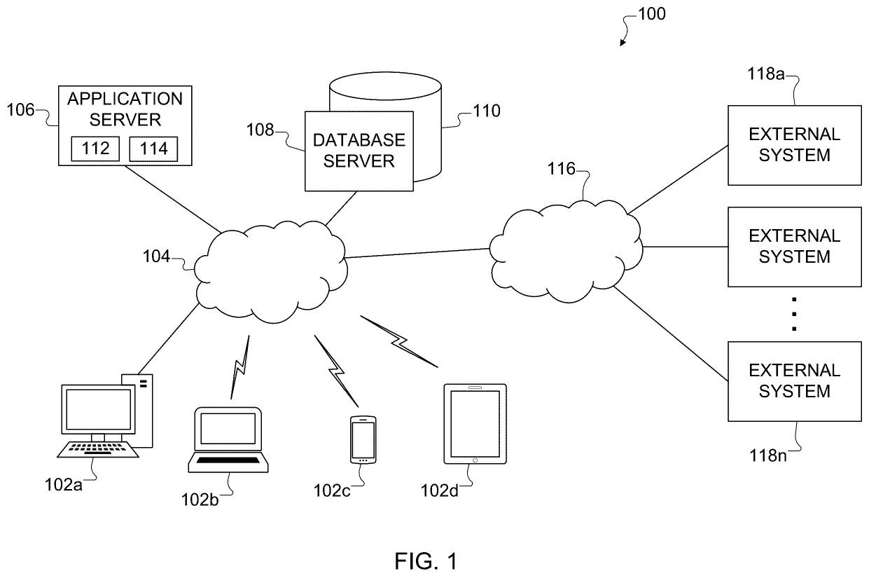

FIGS. 1 through 8, described below, and the various embodiments used to describe the principles of the present invention in this patent document are by way of illustration only and should not be construed in any way to limit the scope of the invention. Those skilled in the art will understand that the principles of the present invention may be implemented in any type of suitably arranged device or system.

As noted above, one issue commonly experienced in agriculture harvesting involves the maximization of total goods that can be extracted from harvested raw crops, typically while minimizing total transportation costs and satisfying constraints like (i) assuring that certain fields are only harvested manually or mechanically and (ii) not producing and transporting more harvested crops than downstream processing capacity can handle. Moreover, harvesting can be affected by a number of unpredictable factors, such as weather and other environmental conditions and community behaviors (like theft). This becomes particularly challenging since the total amount of goods that can be extracted from raw crops is time-varying and since the raw crops can be subject to degradation over time. A specific example of this involves the extraction of sucrose from raw sugar cane, where the amount of sucrose extracted can vary based on (i) the state of the raw sugar cane at the time of harvesting and (ii) the amount of time between harvesting and processing. These types of challenges can be observed in other domains, as well, such as during the maximization of power output from steam engines or during the optimization of chemical processes.

Various optimization models and other optimizers have been developed over the years that attempt to optimize operations during agriculture harvesting, operations within industrial facilities, or other operations. However, these optimizers can suffer from a number of shortcomings. For example, in some applications, certain parameters used by an optimizer are not deterministic and can vary over time, but optimizers are typically designed to process deterministic inputs in order to generate suitable production schedules or other optimized outputs. In these cases, specific input values for the parameters typically need to be estimated, which can introduce errors into the optimization process. For instance, estimates for these parameters' input values may be generated using certain types of data, and these estimates can inherently have some extraneous uncertainties based on the manner in which the estimates are generated (particularly when the certain types of data themselves have associated uncertainties). Moreover, in some cases, input values for specific parameters actually cannot be estimated, and only trajectories for the specific parameters over time might be identified (without identifying actual values for the specific parameters).

As a particular example of this, for sugarcane harvesting or other agricultural harvesting, one fundamental problem in the optimization of agricultural harvesting operations is the maximization of a quantity that depends on both one or more optimized variables as well as one or more time-varying parameters that drive an objective function. In many cases, the time-varying parameters are typically determined by subject matter experts or simple heuristics. In either case, the predictions are not based on a complete representation or understanding of the physical world, so any mathematical optimization framework that operates based on the predictions is not built starting from first principles. For instance, it may be desirable to maximize a quantity of material that can be produced by processing harvested crops, such as when attempting to maximize the amount of sugar produced by processing harvested sugarcane. However, organic materials can degrade over time, and the amount of sugar or other products recoverable in harvested crops is not constant and can vary over time depending (among other things) on the amount of time between harvesting and processing. Thus, for example, the amount of sugar that can be produced using newly-harvested sugarcane may be different if processed today versus if processed tomorrow. While it is possible to sample crops and estimate whether the amount of recoverable sugar or other products is increasing or decreasing over time, this only provides an estimated trend or trajectory of sugar/product recovery and does not give quantifiable information that can be input to and used by an optimizer.

This disclosure provides various machine learning-based approaches and other approaches for generating inputs for optimizers. As described in more detail below, a machine learning model or other logic can be used to process input data for an optimizer and generate predictions for use by the optimizer. Among other things, this allows the machine learning model or other logic to generate actual quantity predictions or other quantifiable predictions that can be used by the optimizer to generate improved production schedules or other outputs. This is true even when one or more of the predictions are associated with one or more time-varying parameters of an agricultural process or other process, thereby allowing improved optimization to occur based on quantifiable predictions associated with otherwise non-deterministic parameters.

Note that the optimizer here may represent any suitable optimizer configured to generate any suitable optimization results, such as an optimizer used for production schedule optimization (PSO) or an optimizer used for process optimization (PrO). In terms of agricultural harvesting, production schedule optimization can generally include identifying a schedule for harvesting crops in one or more specified growing areas, such as based on assignments of work crews or other resources to one or more growing areas or portions thereof over time. Also, in terms of processing harvested products, process optimization can generally include identifying a schedule for processing harvested crops, such as by identifying how equipment in at least one processing facility will be used to process harvested crops. However, the described approaches can be applied in non-agricultural uses cases, as well, such as when increasing or maximizing the power output of a steam engine or when optimizing one or more chemical processes in a plant. Thus, it can more generally be said that the approaches described in this patent document can be used for determining a scheduling status for the use of time-varying resources or elements that are subject to one or more environmental factors.

FIG. 1 illustrates an example system 100 supporting a machine learning-based approach or other approach for generating inputs for an optimizer according to this disclosure. For example, the system 100 shown here can be used to support optimization operations involving agricultural harvesting or other use cases. As shown in FIG. 1, the system 100 includes user devices 102a-102d, one or more networks 104, one or more application servers 106, and one or more database servers 108 associated with one or more databases 110. Each user device 102a-102d communicates over the network 104, such as via a wired or wireless connection. Each user device 102a-102d represents any suitable device or system used by at least one user to provide or receive information, such as a desktop computer, a laptop computer, a smartphone, and a tablet computer. However, any other or additional types of user devices may be used in the system 100.

The network 104 facilitates communication between various components of the system 100. For example, the network 104 may communicate Internet Protocol (IP) packets, frame relay frames, Asynchronous Transfer Mode (ATM) cells, or other suitable information between network addresses. The network 104 may include one or more local area networks (LANs), metropolitan area networks (MANs), wide area networks (WANs), all or a portion of a global network such as the Internet, or any other communication system or systems at one or more locations.

The application server 106 is coupled to the network 104 and is coupled to or otherwise communicates with the database server 108. The application server 106 supports a machine learning-based approach or other approach for generating inputs for an optimizer. For example, the application server 106 may execute at least one machine learning model or other logic 112 that processes input data in order to generate inputs for at least one optimizer 114. The at least one machine learning model or other logic 112 can, for instance, be used to quantify an amount of at least one product estimated to be obtained from crops to be harvested or processed. The at least one optimizer 114 can process input data (including one or more inputs generated by the at least one machine learning model or other logic 112) in order to perform production schedule optimization, process optimization, or other optimization. Note that the database server 108 may also be used within the application server 106 to store information, in which case the application server 106 may store the information itself used to perform production schedule optimization.

The database server 108 operates to store and facilitate retrieval of various information used, generated, or collected by the application server 106 and the user devices 102a-102d in the database 110. For example, the database server 108 may store various information related to fields or other growing areas, crops growing in the fields or other growing areas, resources available for harvesting the crops in the fields or other growing areas, or other information used during optimization. The database server 108 may also store results produced during the optimization.

In this example, at least some of the information used by the application server 106 and/or stored in the database 110 may be received over at least one additional network 116 from one or more external systems 118a-118n. For example, the network 116 may represent a public data network (such as the Internet) or other network that allows the one or more external systems 118a-118n to provide information to and receive information related to agricultural harvesting. As a particular example, the one or more external systems 118a-118n may be used to provide information about weather or other information that can impact agricultural harvesting, where that information can be used by the application server 106 to perform production schedule optimization, process optimization, or other operations.

A determined production schedule or other optimization results produced by the application server 106 may be used in any suitable manner. For example, a determined production schedule may be presented to one or more users, such as via one or more of the user devices 102a-102d. The one or more users may review the determined production schedule, make changes to the determined production schedule, or perform other actions using the determined production schedule. The determined production schedule may also or alternatively be used by the application server 106 or other device to automatically schedule operations to be performed, such as by automatically scheduling work crews, resource assignments, or other actions. Similarly, a determined process optimization may be presented to one or more users, who may review the determined process optimization, make changes to the determined process optimization, or perform other actions using the determined process optimization. The determined process optimization may also or alternatively be used by the application server 106 or other device to automatically schedule operations to be performed, such as by automatically scheduling processing operations involving at least one processing facility. In general, one or more production schedules, process optimizations, or other optimization results may be used in any suitable manner with or without user interaction.

Although FIG. 1 illustrates one example of a system 100 supporting a machine learning-based approach or other approach for generating inputs for an optimizer, various changes may be made to FIG. 1. For example, the system 100 may include any suitable number of user devices 102a-102d, networks 104, 116, application servers 106, database servers 108, databases 110, machine learning models or other logic 112, optimizers 114, and external systems 118a-118n. Also, these components may be located in any suitable location(s) and might be distributed over a large area. In addition, while FIG. 1 illustrates one example operational environment in which a machine learning-based approach or other approach for generating inputs for an optimizer may be used, this functionality may be used in any other suitable system.

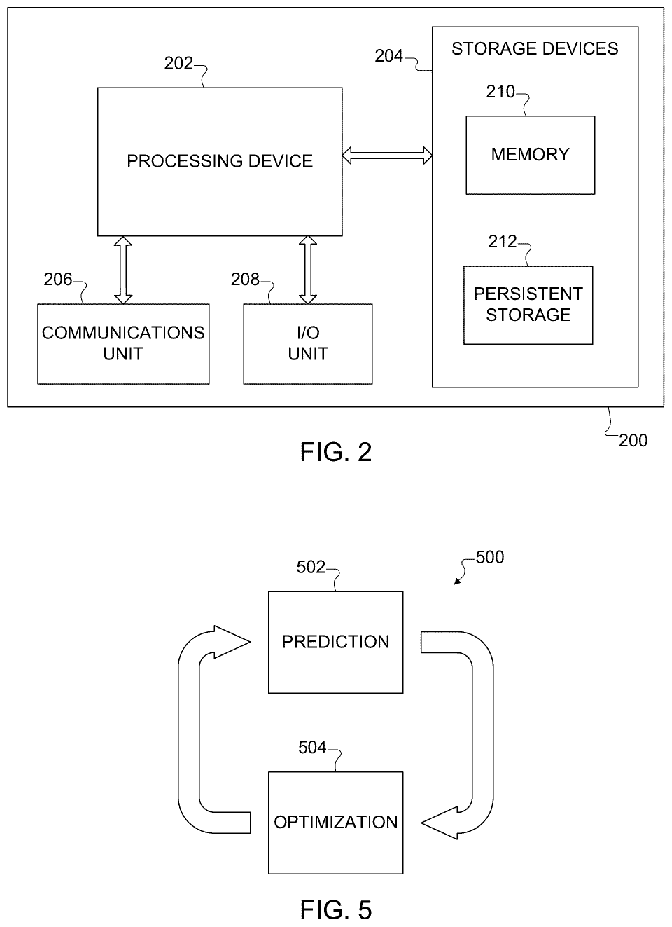

FIG. 2 illustrates an example device 200 supporting a machine learning-based approach or other approach for generating inputs for an optimizer according to this disclosure. One or more instances of the device 200 may, for example, be used to at least partially implement the functionality of the application server 106 of FIG. 1. However, the functionality of the application server 106 may be implemented in any other suitable manner. In some embodiments, the device 200 shown in FIG. 2 may form at least part of a user device 102a-102d, application server 106, database server 108, or external system 118a-118n in FIG. 1. However, each of these components may be implemented in any other suitable manner.

As shown in FIG. 2, the device 200 denotes a computing device or system that includes at least one processing device 202, at least one storage device 204, at least one communications unit 206, and at least one input/output (I/O) unit 208. The processing device 202 may execute instructions that can be loaded into a memory 210. The processing device 202 includes any suitable number(s) and type(s) of processors or other processing devices in any suitable arrangement. Example types of processing devices 202 include one or more microprocessors, microcontrollers, reduced instruction set computers (RISCs), complex instruction set computers (CISCs), graphics processing units (GPUs), data processing units (DPUs), virtual processing units, associative process units (APUs), tensor processing units (TPUs), vision processing units (VPUs), neuromorphic chips, artificial intelligence (AI) chips, quantum processing units (QPUs), cerebras wafer-scale engines (WSEs), digital signal processors (DSPs), application-specific integrated circuits (ASICs), field programmable gate arrays (FPGAs), or discrete circuitry.

The memory 210 and a persistent storage 212 are examples of storage devices 204, which represent any structure(s) capable of storing and facilitating retrieval of information (such as data, program code, and/or other suitable information on a temporary or permanent basis). The memory 210 may represent a random access memory or any other suitable volatile or non-volatile storage device(s). The persistent storage 212 may contain one or more components or devices supporting longer-term storage of data, such as a read only memory, hard drive, Flash memory, or optical disc.

The communications unit 206 supports communications with other systems or devices. For example, the communications unit 206 can include a network interface card or a wireless transceiver facilitating communications over a wired or wireless network, such as the network 104 or 116. The communications unit 206 may support communications through any suitable physical or wireless communication link(s).

The I/O unit 208 allows for input and output of data. For example, the I/O unit 208 may provide a connection for user input through a keyboard, mouse, keypad, touchscreen, or other suitable input device. The I/O unit 208 may also send output to a display, printer, or other suitable output device. Note, however, that the I/O unit 208 may be omitted if the device 200 does not require local I/O, such as when the device 200 represents a server or other device that can be accessed remotely.

Although FIG. 2 illustrates one example of a device 200 supporting a machine learning-based approach or other approach for generating inputs for an optimizer, various changes may be made to FIG. 2. For example, computing and communication devices and systems come in a wide variety of configurations, and FIG. 2 does not limit this disclosure to any particular computing or communication device or system.

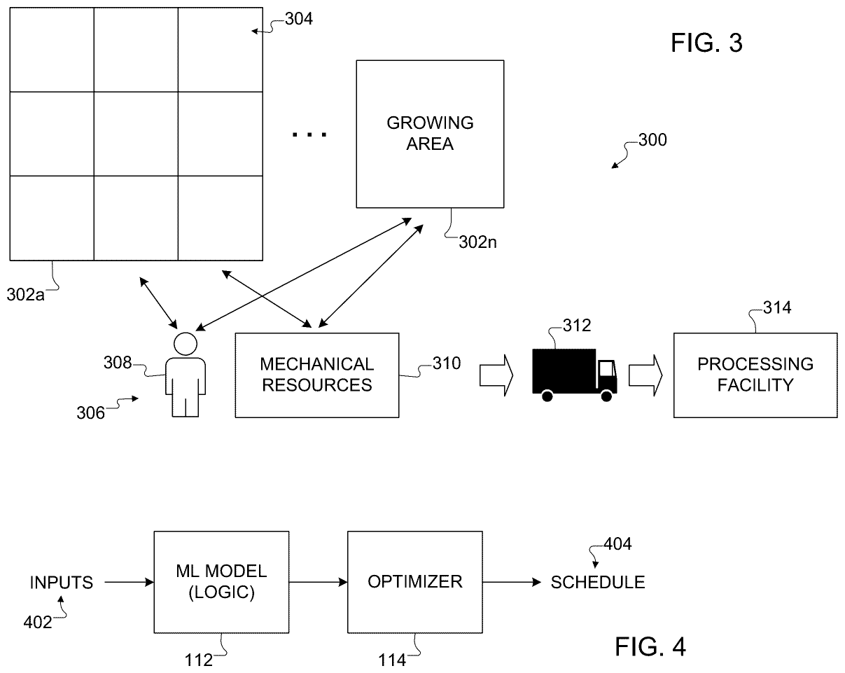

FIG. 3 illustrates an example environment 300 in which a machine learning-based approach or other approach for generating inputs for an optimizer can be used according to this disclosure. More specifically, FIG. 3 illustrates an example environment 300 for which the system 100 may be used to schedule harvesting or processing operations associated with at least one agricultural product. However, this is merely one example, and the system 100 may be used in or in conjunction with any other suitable environment.

As shown in FIG. 3, one or more growing areas 302a-302n can represent fields or other areas in which one or more crops are grown. Each growing area 302a-302n can have any suitable size, shape, and dimensions, and each growing area 302a-302n may be used to grow any suitable crops. Different growing areas 302a-302n may be located adjacent or otherwise close to each other or spaced relatively far (and possibly very far) apart. One or more of the growing areas 302a-302n may optionally be divided into multiple lots 304, where each lot 304 represents a portion of the associated growing area 302a-302n. Each lot 304 can have any suitable size, shape, and dimensions. Each growing area 302a-302n may have any suitable number and arrangement of lots 304, and different growing areas 302a-302n may or may not have the same number or arrangement of lots 304.

Harvesting of crops grown in the growing areas 302a-302n can be performed using various resources 306. In this example, the resources 306 include human work crews 308 and mechanical resources 310. The human work crews 308 represent one or more groups of people who can harvest crops manually, while the mechanical resources 310 represent one or more automated or human-operated pieces of equipment that can be used to harvest crops mechanically. The system 100 can be used as described below to schedule harvesting of different growing areas 302a-302n or lots 304 of the growing area 302a-302n by different resources 306, such as by generating one or more schedules that indicate which growing areas 302a-302n or lots 304 will be harvested by the resources 306 and when. As a particular example, different resources 306 may be assigned to harvest crops from different growing areas 302a-302n or lots 304 so that harvesting by each resource 306 can be focused on a cluster of lots 304 within a given two-week period or other portion of a harvesting season. Often times, a schedule can be generated from an initial 60-day planning or other planning that occurs before the two-week period or other portion of the harvesting season, such as to reduce or minimize transportation costs for heavy machinery (mechanical resources 310) used during harvesting.

The ability to generate schedules in which resources 306 are assigned to harvest from clusters of lots 304 can help to avoid issues with too many crops becoming ripe at or near the same time. For example, harvest planners can stagger the planting of the crops and/or the introduction of ripening agents to the crops, and this staggering can help to reduce or avoid the likelihood of all or a large portion of the crops becoming ripe at or near the same time. Since there is typically no capacity to harvest all crops at the same time, this allows the same resources 306 to be assigned to different clusters of lots 304, since those different clusters of lots 304 can have crops that ripen at different times. As a result, in a given two-week window or other time period, there are a much smaller number of lots 304 that can be predicted to be ready for harvesting.

Harvested crops are generally transported, such as via one or more trucks 312, to one or more processing facilities 314 for processing. Each truck 312 can have any suitable capacity for hauling harvested crops, and different trucks 312 may or may not have different capacities. In some embodiments, different trucks 312 may include different numbers of trailers and therefore have different capacities. As a particular example, a double truck 312 may have two trailers, a high-performance truck 312 may have four or five trailers, a max-performance truck 312 may have up to seven trailers, and each trailer may have a 100-ton capacity. However, these examples of the trucks 312 and their capacities are for illustration only.

Each processing facility 314 can be used to process harvested crops, such as by extracting sugar from harvested sugarcane, removing seeds from harvested corn, or otherwise processing the harvested crops. For certain crops, transportation may need to happen within the same day or other close time period in order to reduce or minimize content loss and/or waste, such as due to degradation of the harvested crops. For example, sugarcane often needs to be processed on the same day it is harvested in order to maximize sugar recovery. However, each processing facility 314 has limited processing capacity (such as in terms of tons per day), and both planned and unplanned downtimes of the processing facility 314 can occur. As a result, it is generally not feasible to transport an arbitrary quantity of harvested crops to each processing facility 314.

The system 100 can be used as described below to optimize agricultural harvesting operations involving crops in the growing areas 302a-302n so that production quantity of one or more products by the one or more processing facilities 314 can be increased or maximized, possibly while reducing or minimizing total transportation and operational costs. In the context of agricultural harvesting, it should be noted that production quantity (the amount of product(s) produced by the one or more processing facilities 314) is different than harvesting quantity (the amount of crops harvested using the resources 306). This is due to the fact that harvested crops are organic materials and can degrade over time, or certain crops might simply not be enough ripe to be harvested. This behavior can be modeled using a time-varying parameter, which is referred to below as a “yield rate.” The yield rate can be predicted using a sophisticated model, such as a data-driven model or other type of model. In some cases, harvest planners may typically be interested in reducing or minimizing costs, but increasing or maximizing production quantity may take priority. In some embodiments, an objective function used by an optimizer 114 can include a weighted sum of production quantity and cost, and the weights can be varied in order to achieve a desired trade-off between production quantity and cost.

During optimization, it may be assumed that all human work crews 308 and mechanical resources 310 will operate at full capacity during all assigned harvesting operations. Also, in many instances, agriculture harvesting of each growing area 302a-302n or lot 304 may be performed either manually or mechanically, and it may be assumed that either manual human work crews 308 or mechanical resources 310 (but not both) are assigned to harvest crops in each cluster of lots 304. Having said that, there may be a strong preference in some instances for harvesting given growing areas 302a-302n or lots 304 exclusively with human work crews 308 or mechanical resources 310. In addition, there are often specific circumstances to be taken into account. For instance, it may be true that any growing area 302a-302n that can be harvested mechanically can also be harvested manually, but it may also be true that certain growing areas 302a-302n or lots 304 should only be harvested manually. Given that, the optimizer 114 can prioritize directing human work crews 308 to growing areas 302a-302n or lots 304 that should only be harvested manually, and mechanical resources 310 can be assigned to other growing areas 302a-302n or lots 304 whenever possible.

The optimizer 114 can be used to take all of this information into account in order to generate a schedule that assigns human work crews 308 and mechanical resources 310 to harvesting different clusters of lots 304 in one or more growing areas 302a-302n over a two-week or other time horizon. The generated schedule may be expressed in any suitable manner depending on the implementation and may include any related information. In some cases for instance, a generated schedule may include, for each cluster of lots 304, a distance between that cluster and an associated processing facility 314, a truck 312 to be used, a maximum speed of the truck 312, a number of cycles of the truck 312 between the cluster of lots 304 and the processing facility 314, a type of harvest (manual or mechanical), a type of harvester and its associated efficiency (such as in tons per day), an estimated transport cost, an estimated total harvested quantity (such as in tons), an estimated purity of the harvested crops, and an estimated brix of the harvested crops. Brix represents a measure of dissolved solids (such as sugar) in a liquid. Note, however, that each generated schedule may include any other or additional information as needed or desired depending on the circumstances.

In some embodiments, an objective function, decision variables, problem coefficients, constraints, and algorithm to generate a harvesting scheduling can be defined as follows. The following sets can be defined and used during optimization. Let L denote the number of lots 304 to be harvested in a given two-week or other horizon. In some cases, |L|≈300. Let Lₘₐ denote the lots 304 that can only be harvested manually. Assume that a lot 304 can be harvested manually if the lot 304 can be harvested mechanically. Let F denote the set of resources 306 including human work crews 308 and mechanical resources 310. Assume that an assignment of a resource 306 to a cluster of lots 304 will include only manual resources 306 or only mechanical resources 306 (not both). In some cases, there may be a strong preference for harvesting a given growing area 302a-302n or lot 304 exclusively with one or the other. Given that, Fₘₐ and Fₘₑ respectively represent manual and mechanical resources 306, where F=Fₘₐ ∪Fₘₑ. Let M denote the set of all trucks 312 that are available for use during harvesting. In some cases, it may be assumed that there are three types of trucks 312, each having a different capacity as described above. Given that, for m∈{1, 2, 3}, let Mm represent the set of trucks 312 from type m, meaning M=∪Mm. Let H denote the set of all harvesters, which can vary based on their different efficiencies (such as tons per day). If there are three harvesters, for instance, for m∈{1, 2, 3}, let Hₘ denote the set of harvesters from type m, meaning H=∪Hₘ. Let T represent a set of timestamps, such as the number of days in a planning horizon. In some cases, |T|=15. Let S denotes a set of holders, where Sm denotes a set of holders for manual harvesting.

The following decision variables can be defined and used during optimization. Let x_{l,t}∈ [symbol] ₊ represent the total amount of harvested crops (such as in tons or kilograms) from lot/on day, where l∈L and t∈T. Let z_{l,t}^{m}∈{0, 1} indicate whether truck m is scheduled for lot/during day 1, where l∈L, l∈L, and m∈M. Let f_{l,t}^{j} ∈{0, 1} indicate whether human work crew j is scheduled for lot l during day t, where l∈L, l∈L, and j∈F. Let c_{l,t}^{m}∈ [symbol] , represent the number of cycles (back and forth trips between a lot 304 and a processing facility 314) that truck m makes on day t for lot l. Let q_{l,t}^{m}∈ [symbol] ₊ represent the total amount of crops (such as in tons or kilograms) assigned to truck m from lot l on day t, where l∈L, l∈L, and m∈M. Let θₗ^{t}∈{0, 1} indicate whether lot/is selected to be harvested manually on day 1, where l∈L \ Lₘₐ and t∈T.

The following parameters can be defined and used during optimization. Let Di represent the distance of lot l to an associated processing facility 314, where l∈L. Let Kₜ represent the capacity of a processing facility 314 on day t (with downtime considered). Let Vₗ∈ [symbol] ₊³ represent the maximum speed of each type of truck 312 on lot l, where l∈L. Let C∈ [symbol] ₊³ represent the capacity of each type of truck 312, which can be fixed in the horizon. Let N_{m,t} represent the total amount of hours that truck m is available on day t, where m∈M and t∈T. Let P_{l,t} represent the amount of crop that can be extracted from per ton of harvest on day t from lot l, where l∈L and t∈T. This value is referred to as “purity” in sugarcane harvesting or “yield rate” in corn harvesting and is typically given in terms of percentage. The phrase “yield rate” is used in this document to represent this value. Let Eₗ∈ [symbol] ₊³ represent the transportation cost of harvested crop per unit distance (such as per mile or per kilometer) assuming full capacity for lot j for each truck type. Here, it can be assumed that the transportation cost varies based on the terrain or lot. Let μₘₐ and μₘₑ represent the harvesting rates (such as in tons per day) of manual and mechanical harvesting, respectively. Let Π_{M}, Π_{H}∈{0, 1}^{M×3} respectively map trucks and harvesters to their corresponding types.

Based on this, it is possible to define an objective function to be used by the optimizer 114 in order to optimize harvesting schedules. In some cases, the objective function can be defined using mixed-integer linear programming (MILP). As a particular example, in some embodiments, the objective function may be defined as follows.

$$min - ( {λ}_{1} {\sum }_{t ∈ T} {\sum }_{l ∈ L} {P}_{t , j} {x}_{l , t} ) + {λ}_{2} {\sum }_{m ∈ M} {\sum }_{t ∈ T} {\sum }_{l ∈ L} {z}_{l , t}^{m} {c}_{l , t}^{m} {D}_{l} {Π}_{M} [ m , : ] {E}_{l} + {λ}_{3} {\sum }_{t ∈ T} {\sum }_{l ∈ L} {\sum }_{j ∈ F} {f}_{l , t}^{j} - {λ}_{4} {\sum }_{t ∈ T} {\sum }_{l ∈ L \backslash {L}_{ma}} \vert {\sum }_{j ∈ {F}_{ma}} {f}_{l , t}^{j} - {\sum }_{{j}^{′} ∈ {F}_{m c}} {f}_{l , t}^{{j}^{′}} \vert \qquad ( 1 )$$

In Equation (1), the first term considers the amount of goods to be extracted in a horizon among all growing areas 302a-302n based on time-varying yield rates, the second term represents total transportation costs, the third term minimizes resource assignments, and the fourth term penalizes mix harvesting (meaning attempts to have both mechanical and manual harvesting of the same lots 304). The capacity constraints on a processing facility 314 can be defined as follows.

$${\sum }_{l ∈ L} {x}_{l , t} \leq {K}_{t} . ∀ t ∈ T \qquad ( 2 )$$

The capacity constraints on the trucks 312 can be defined as follows.

$${\sum }_{m ∈ M} {c}_{l , t}^{m} {z}_{l , t}^{m} {Π}_{M} [ m , : ] {C}_{m} \geq {x}_{l , t} , ∀ t ∈ T , ∀ l ∈ L \qquad ( 3 )$$

A harvesting capacity-to-total production constraint can be defined as follows.

$${\sum }_{j ∈ {F}_{m a}} {f}_{l , t}^{j} {μ}_{m a} + {\sum }_{j ∈ {F}_{m c}} {f}_{l , t}^{j} {μ}_{m c} \geq {x}_{l , t} , ∀ t ∈ T , ∀ l ∈ L \qquad ( 4 )$$

Enforcing the rule that Fₘₐ (manual resources 306) only be assigned to Lₘₐ (lots 304 that can only be harvested manually) can be expressed as follows.

$${x}_{l , t} \leq {\sum }_{j ∈ {F}_{m a}} {f}_{l , t}^{j} {μ}_{ma} ∀ t ∈ T , ∀ l ∈ {L}_{m a} \qquad ( 5 )$$

A quantity-to-cycle constraint can be defined as follows.

$${c}_{t , l}^{m} \geq \frac{{q}_{l , t}^{m}}{{Π}_{M} [ m , : ] {c}_{m}} \qquad ( 6 )$$

$${c}_{t , l}^{m} - 1 \leq \frac{{q}_{l , t}^{m}}{{Π}_{M} [ m , : ] {c}_{m}} + ϵ , ∀ t ∈ T , ∀ m ∈ M , ∀ l ∈ L \qquad ( 7 )$$

$${\sum }_{m ∈ M} {q}_{l , t}^{m} {z}_{l , t}^{m} \leq {x}_{l , t} , ∀ t ∈ T , ∀ l ∈ L \qquad ( 8 )$$

A cycle-to-speed constraint can be defined as follows.

$${c}_{t , l}^{m} {D}_{l} \leq {N}_{m , t} {z}_{l , t}^{m} {Π}_{M} [ m , : ] {V}_{l} , ∀ t ∈ T , ∀ m ∈ M , ∀ l ∈ L \qquad ( 9 )$$

The optimizer 114 can therefore use this objective function (or this type of objective function) and these constraints (or these types of constraints) to determine how to schedule harvesting in the growing areas 302a-302n using the resources 306.

FIG. 4 illustrates an example machine learning-based approach or other approach for generating inputs for an optimizer 114 according to this disclosure. As described above, while some terms in Equation (1) can be determined deterministically (such as transportation costs), the objective function in Equation (1) includes at least one term that is based on time-varying yield rates. The optimizer 114 typically needs quantifiable inputs in order to operate effectively, and time-varying inputs like time-varying yield rates typically cannot be determined deterministically. To help compensate for this, a machine learning model or other logic 112 can be used to process inputs 402 in order to generate one or more inputs for the optimizer 114. The inputs 402 here may include one or more inputs intended to be provided to the optimizer 114 but that are first modified or otherwise processed using the machine learning model or other logic 112. The inputs 402 here may also or alternatively include data from one or more data sources (such as the database 110 or one or more external systems 118a-118n) that can be processed by the machine learning model or other logic 112 in order to derive or otherwise generate one or more inputs for the optimizer 114. As an example of the latter, the machine learning model or other logic 112 may process data from a number of sources, such as data related to weather, locations of crops, irrigation supplied to the crops, ripeness of the crops, field types in which the crops are growing, or others, in order to generate estimates of recoverable product(s) from the crops based on when the crops are or could be scheduled for harvesting.

Here, the optimizer 114 is effectively performing optimization using partial knowledge of first principles. First principles represent fundamental operations of an underlying system, and the first principles of the underlying system can be known in some cases. However, in other cases, first principles of the underlying system cannot be defined with specificity because of various uncertainties associated with either the underlying system itself or in inputs to the underlying system. For example, there may be physical properties of materials (such as harvested crops) or physical properties of processing equipment (such as mills or other crop processing equipment) that are not measured or measurable. To help compensate for this, the machine learning model or other logic 112 is used to mimic the physics or other behaviors of the crops being grown so that useful information can be provided to the optimizer 114. In other words, the machine learning model or other logic 112 is used to mimic the first principles of the underlying agricultural system or other system and may be based on a partial understanding of the first principles of the underlying system. The information obtained using the machine learning model or other logic 112 is provided to the optimizer 114. In this example, the optimizer 114 produces a schedule 404, which can identify which resources 306 are assigned to harvest from which growing areas 302a-304n or lots 304 and when.

In the equations and description above, it is assumed that the optimizer 114 is being used for production schedule optimization, where resources 306 are assigned to harvesting crops from lots 304 with a goal of increasing or maximizing product production quantity (possibly while reducing or minimizing transportation costs or other costs). However, the same type of approach can be used to support process optimization, where the optimizer 114 is used to determine how equipment in at least one processing facility 314 operates. Again, this can be done with a goal of increasing or maximizing product production quantity (possibly while reducing or minimizing operating costs or other costs).

To support process optimization, an objective function could be generated, such as based on the equipment used in the processing facility 314. Based on that, the optimizer 114 can use the objective function to control operations of the equipment in each processing facility 314. Here, the machine learning model or other logic 112 can be used to mimic the first principles of the underlying equipment in the processing facility 314, which enables the machine learning model or other logic 112 to predict various characteristics of the process. This information can be used by the optimizer 114 to control the equipment in the processing facility 314, such as by setting one or more setpoints used by the equipment in the processing facility 314. Examples of setpoints that might be controlled could include imbibition water flow rate, flocculant flow rate, and wash water flow rate. Setpoints that might be controlled could also or alternatively include ratios of settings, such as an (imbibition water/cane rate) ratio or a (flocculant/clarifier flow rate) ratio.

The machine learning model or other logic 112 can be implemented in any suitable manner. In some cases, for example, the machine learning model or other logic 112 is implemented using a machine learning model architecture, such as a neural network. The neural network or other machine learning model architecture can be trained in any suitable manner, such as by providing training data to the machine learning model architecture and modifying weights or other parameters of the machine learning model architecture until the machine learning model architecture generates suitably-accurate results. This can train the machine learning model architecture to predict various parameters with a desired level of accuracy. In other cases, the machine learning model or other logic 112 may use one or more stochastic optimization techniques, such as simulation-based techniques (like Monte Carlo simulation) or reinforcement learning techniques, to perform optimization with uncertainty.

In whatever manner the machine learning model or other logic 112 is implemented, the machine learning model or other logic 112 is used within an optimization framework to handle the time-varying nature of one or more parameters in the objective function of the optimizer 114. As a result, the machine learning model or other logic 112 can be used in applications like the one shown in FIG. 3, where the machine learning model or other logic 112 can be used in a MILP or other optimization framework to support optimizations involving one or more growing areas 302a-302n, each of which can have a different yield rate for each day or other time period. The machine learning model or other logic 112 can be used to help estimate the net amount of goods that can be extracted from raw crops by determining a time-varying estimate of the true amount. In this way, the machine learning model or other logic 112 and the optimizer 114 can be used to perform optimization with partial knowledge of first principles. The machine learning model or other logic 112 can also be configured to generate predictions even in the absence of some input data, which allows the machine learning model or other logic 112 to support data completeness.

FIG. 5 illustrates an example iterative process 500 in which a machine learning-based approach or other approach for generating inputs for an optimizer can be used according to this disclosure. As shown in FIG. 5, the process 500 includes a prediction stage 502 and an optimization stage 504. The prediction stage 502 generally represents operations performed by the machine learning model or other logic 112 to generate predictions of one or more time-varying parameters, and the optimization stage 504 generally represents operations performed by the optimizer 114 to generate schedules or other optimized outputs. The optimization stage 504 here generate schedules or other optimized outputs based at least partially on the predictions of the one or more time-varying parameters.

As can be seen in FIG. 5, at least some of the outputs or other data generated during the optimization stage 504 can be provided as feedback to the prediction stage 502. In some prior agricultural optimization approaches, prediction and optimization are completely separate processes, where prediction is typically performed and then the resulting predicted values are provided as inputs for use during optimization. This approach tends to be slow, which becomes particularly problematic when growers or other parties wish to run multiple simulations to see whether product yields can be improved by varying harvesting schedules. Simulations that require significant amounts of time can limit the number of different scenarios that can be analyzed.

The approach shown in FIG. 5 combines the use of prediction and optimization in an iterative manner, which can provide various advantages. For instance, the prediction stage 502 implemented using the machine learning model or other logic 112 can more effectively handle the presence of outliers in the inputs 402, since the machine learning model or other logic 112 can be used to provide suitable predictions based on the inputs 402 even in the presence of outliers. Similarly, the prediction stage 502 implemented using the machine learning model or other logic 112 can more effectively handle the presence of imperfections (such as outliers) in the inputs 402, since the machine learning model or other logic 112 can be used to provide suitable predictions based on the inputs 402 even in the presence of data imperfections. In some cases, outliers can be determined based on one or more statistical tools (such as one or more statistical tests, residual analyses, or machine learning algorithms for outlier detection) and an understanding of the underlying system's first principles (such as physical rules regarding how crops grow or how sucrose extraction equipment or other processing facility equipment operates.

In some embodiments, the presence of outliers can be handled via suitable training of the machine learning model or other logic 112. For example, a machine learning model may be constructed using a full time-series dataset, which can include outliers. A machine learning model error is calculated by taking the difference between time-series predictions generated by the machine learning model and the actual time-series data, and a distribution of the error data is calculated. Data points within the time-series data outside a specified error distribution threshold (such as two or three standard deviations away from a mean) can be determined to be outliers and removed from the time-series data, creating a cleaned dataset. The process can be repeated by returning to the calculation of the machine learning model error (the second step) and performing the subsequent steps again until one or more criteria are met. For instance, a number of points in the cleaned dataset that do not meet the threshold may be below a threshold amount (such as less than 1%), or the cleaned data may be reduced below a threshold size (such as 80% of the full dataset size). At that point, the dataset may be determined to be suitably clear of outliers.

Moreover, the ability to feed back optimizations for use during subsequent predictions may allow for the effects of the optimizations to be taken into account when generating additional predictions. Thus, for instance, effects of harvesting during a current planning horizon can be used to determine the impacts of the harvesting during subsequent planning horizons, which makes it possible to determine over a longer time period how to increase or maximize production. Further, feeding back optimizations can help the machine learning model or other logic 112 to identify predictions that might not have been correct or accurate, such as predictions suffering from excessive prediction error. If the machine learning model or other logic 112 is able to take these prediction errors into consideration when generating additional predictions, the machine learning model or other logic 112 may be able to generate more accurate predictions over time. In addition, the ability to speed up optimization operations can help to avoid the use of stale data. In some cases, for example, there may be a need or a desire to generate optimizations daily or during some other relatively-short time periods, and the described techniques can help optimizations occur more quickly and thereby enable generation of optimizations using more-recent data.

Note that the described techniques may be easily scaled to support optimizations involving any number of growing areas 302a-302n and/or any number of processing facilities 314. As long as one or more machine learning models or other logic 112 can be used to generate suitable predictions of one or more time-varying parameters associated with the growing areas 302a-302n or processing facilities 314, one or more optimizers 114 can be used to process inputs including the predictions of the one or more time-varying parameters in order to optimize harvesting and/or processing of crops. Thus, for instance, growing areas 302a-302n can be divided by continent or other geographical boundaries, and different machine learning models or other logic 112 can be used with different groups of growing areas 302a-302n associated with different continents or other geographical boundaries. Also, one or more growing areas 302a-302n may be able to provide harvested crops to multiple processing facilities 314, and one or more machine learning models or other logic 112 can be used to generate different predictions based on which processing facility 314 received certain harvested crops.

It should be noted that a substantial number of fields or other growing areas 302a-302n, together with long harvesting schedules, can typically make an optimization problem prohibitively difficult to solve in a short amount of time (such as within hours). Consequently, harvesting planners tend to distribute growing areas 302a-302n over a longer time horizon, where a cluster of growing areas 302a-302n or lots 304 is harvested within a period of interest. These growing areas 302a-302n or lots 304 can be selected based on predicting certain parameters specific to each crop type. For instance, in sugarcane harvesting, purity and brix can be considered. In corn or soybean harvesting, the yield rate can be considered. These predictions rely on a variety of data sources, such as satellite images of fields, watering types (like drip or aspersion), the number of applications of fertilizer, the kind(s) of fertilizer applied, the dosage(s) of fertilizer/ripening agent applied, the age of each field, and many others.

In the agricultural harvesting optimization problem, predictions will be included as parameters of the objective function, so it can be crucial to accurately predict those values. Yield rates can be predicted automatically, such as by using at least one machine learning model or other logic 112, for an optimization horizon. In some cases, this can be accomplished using one or more external data resources. An optimizer 114 can therefore have the capability of dynamically adjusting clusters of growing areas 302a-302n or lots 304 and a time horizon to be optimized. Furthermore, it is also possible to directly consider the uncertainty in an objective term without explicitly predicting certain parameters, such as by applying stochastic optimization, reinforcement learning, or other decision-making techniques. The techniques described in this disclosure enable more accurate predictions to be provided to an optimizer 114 for use.

Harvesting and transportation of organic materials to processing facilities 314 are often complex operations that require careful planning throughout the entire harvesting season. Harvesting planners are typically interested in maximizing the yield of their crops, such as yield measured in tons of sugar per hectare for sugarcane harvesting or kilograms of seeds per hectare for corn harvesting. Determining the yield parameter is a complex task that depends on various types of external data, such as weather, location, irrigation, ripeness, field type, and potentially many others depending on the individual application. The fact that some of these variables are time-varying and resources and capacities are limited make the associated optimization problem suitable to be formulated as a multi-horizon multi-objective mathematical program. In its simplest form, the solution to such an optimization problem may result in a resource assignment plan indicating which resources 306 should be allocated to a given field or other growing area 302a-302n during a given day or other time period. In many cases, harvesting currently depends on a combination of manually-generated schedules and on-site observations. Consequently, schedules are slow to react to changing conditions and are unable to properly balance ripeness, yield, and mill capacity. As a result, parties may occasionally rely on third-party trucks, mills, or other resources or may need to harvest in low yield rate regimes, such as after sugar levels have begun to degrade, which can significantly increase operational costs.

The techniques described in this patent document support the use of an optimization framework for agricultural harvesting processes, which can be applied to real harvesting scenarios (including many fields or other growing areas 302a-302n with time-varying yield rates). Such a formulation might still contain numerous binary variables, such as thousands or tens of thousands of variables. Also, parties might be interested to see proposed schedules for different scenarios. As a result, any optimization can be sufficiently fast in order to handle a large number of variables and to generate proposed schedules for different scenarios. In order to accomplish this, to make the problem tractable in a reasonable time, one approach can be to restrict the number of fields or other growing areas 302a-302n or lots 304 and days or other time periods under consideration. This can indeed be the case in practice, where harvesting planners follow a hierarchical approach. For instance, a base harvest schedule (typically several months of horizon) can be generated, which yields an overall budget. After that, to reduce the number of growing areas 302a-302n or lots 304 (which may typically be on the order of thousands), a ripening schedule can be applied. This produces a set of growing areas 302a-302n or lots 304 with their known ripening distributions or yield rates over the next several weeks, and a harvesting schedule for this last operation can be optimized as discussed above.

Although FIGS. 3 through 5 illustrate one example of a machine learning-based approach or other approach for generating inputs for an optimizer and related details, various changes may be made to FIGS. 3 through 5. For example, the specific environment 300 shown in FIG. 3 is for illustration only. Also, any suitable number of machine learning models or other logic 112 and any suitable number of optimizers 114 may be used. In addition, a machine learning model or other logic 112 may be used with an optimizer 114 as part of an iterative process 500 as shown in FIG. 5 or as part of a non-iterative process, such as one in which outputs from the machine learning model or other logic 112 are provided to the optimizer 114 without feedback.

Note that U.S. Patent Publication No. 2023/0297089 A1 (which is hereby incorporated by reference in its entirety) discloses a resource-task network (RTN)-based templated production schedule optimization framework. Consider the harvesting process of a field or other growing area 302a-302n and assume that the total amount of crop that can be harvested at the beginning of a planning horizon is known. Also assume that the yield rate of the crop in this growing area 302a-302n is represented by a parameter, a value for which may be obtained in any suitable manner (such as those discussed above). In some cases, this parameter could represent the percentage of sugar that can be extracted from raw sugarcane. On a given day, an optimizer 114 can decide to harvest a certain amount of crop from this growing area 302a-302n by considering the yield rate, the available crop, and available resources 306, and this decision determines the availability of the crop on the following day. A similar context is introduced in U.S. Patent Publication No. 2023/0297089 A1, where an inventory level for each material being used in a process can be calculated based on the resource-task relation that binds the material. This relation is referred to as a material balance constraint, and the formulation provided in this patent document follows the same idea. However, RTN-based PSO is not directly applicable here due to the uncertainties on the objective function through the yield rate, which can be propagated with different approaches like tuning ripening agents and making it part of the decision variables (which may not be supported by the RTN-based PSO).

In one example, an optimizer 114 generates a schedule for harvesters and crews daily, meaning it is known which resources 306 and which trucks 312 are assigned to each field or other growing area 302a-302n on the horizon. The next step can be to optimize the schedule at a daily level, where a goal can be to minimize the total span time of each crew or other resource 306 being used within the day within that growing area 302a-302n. This can also depend on additional constraints, such as shifts of workers. Again, this closely resembles the framework disclosed in U.S. Patent Publication No. 2023/0297089 A1, where a production plan may be generated at a daily level and a sub-daily production schedule can then be generated. Thus, the techniques disclosed in U.S. Patent Publication No. 2023/0297089 A1 may be used here to support generation of a sub-daily production schedule.

Also note that in the above description, it has been assumed that the machine learning model or other logic 112 is used to generate predictions for one or more time-varying parameters used by an optimizer 114. However, predictions often have associated uncertainties, and one issue that can arise is how to deal with these uncertainties. In some embodiments, stochastic approaches may be used, such as by sampling from distributions defined by the uncertainties, in order to generate the predictions. This may or may not be performed using the machine learning model or other logic 112.

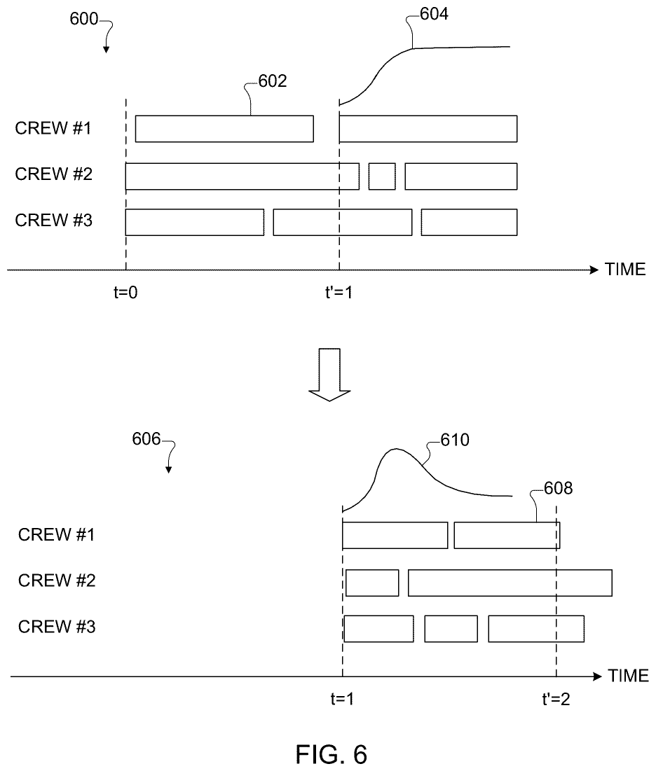

FIG. 6 illustrates an example type of schedule that could be generated using a machine learning-based approach or other approach for generating inputs for an optimizer according to this disclosure. For example, this type of schedule may be generated using a machine learning model or other logic 112 and an optimizer 114 of an application server 106 as described above. However, this type of schedule may be generated using any suitable device(s) and in any suitable system(s).

As shown in FIG. 6, an initial schedule 600 may be generated during an optimization for a specific time period starting at time t=0. The initial schedule 600 includes assignments 602 that identify when crews or other resources are assigned to perform crop harvesting or other functions. Each assignment 602 may represent an assignment of a specific crew or other resource to a particular growing area 302a-302n or a particular lot 304 or collection of lots 304. In this example, the initial schedule 600 is generated based on a prediction 604 of a quantity of at least one recoverable product that is projected to be obtained as a result of the crop harvesting.

During the next optimization, an updated schedule 606 may be generated for a specific time period starting at time t=1. The updated schedule 606 also includes various assignments 608 that identify when the same crews or other resources are assigned to perform crop harvesting or other functions. However, it can be seen here that the assignments 608 have changed relative to the assignments 602, which can be due to an updated prediction 610 of the quantity of the at least one recoverable product that is projected to be obtained as a result of the crop harvesting. The change in the prediction may be due to any number of factors, such as changes in weather or other time-varying conditions. As can be seen here, the described techniques can enable optimization to occur repeatedly and to adjust the use of resources based on updated optimization results. In some cases, optimization could be performed periodically, such as daily, or at any other suitable times.

Although FIG. 6 illustrates one example of a type of schedule that could be generated using a machine learning-based approach or other approach for generating inputs for an optimizer, various changes may be made to FIG. 6. For example, schedules for resource usage may be expressed in any number of ways, and FIG. 6 does not limit the scope of this disclosure to any particular implementation.

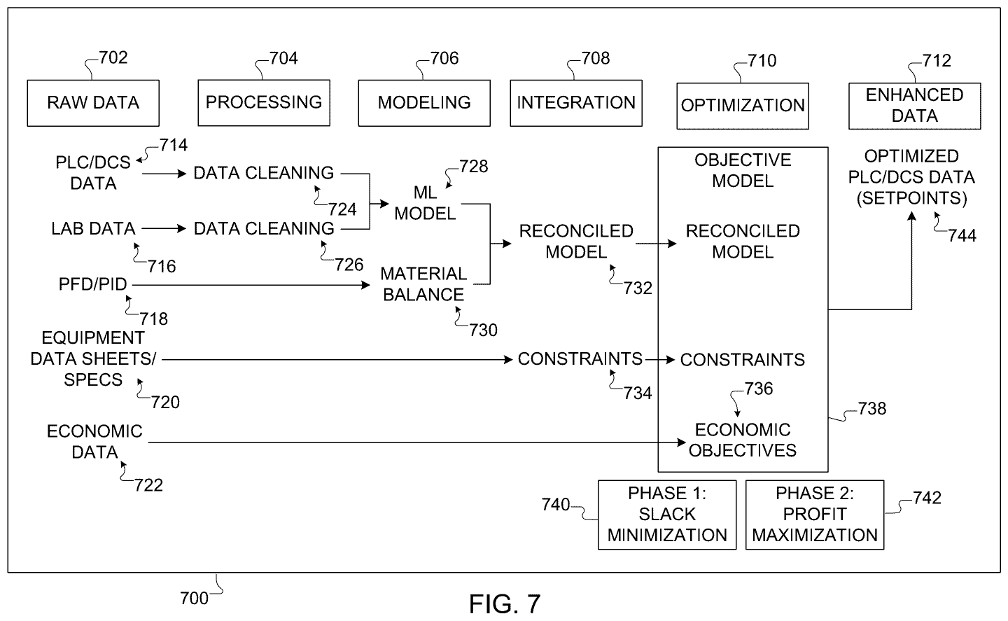

FIG. 7 illustrates an example process 700 for using a machine learning-based approach or other approach for generating inputs for an optimizer according to this disclosure. The process 700 may, for example, be performed using a machine learning model or other logic 112 and an optimizer 114 of an application server 106 as described above. However, the process 700 may be performed using any suitable device(s) and in any suitable system(s).

As shown in FIG. 7, the process 700 generally includes a number of sub-processes 702-712 that can be collectively used to perform process optimization. In this example, the sub-process 702 represents or includes operations used to obtain process-related data from one or more data sources. In some embodiments, the process-related data represents data associated with at least one processing facility 314 being used to process harvested crops. Any suitable process-related data can be obtained here.

In this particular example, the process-related data includes programmable logic controller (PLC)/distributed control system (DCS) data 714 associated with at least one processing facility 314. For example, the PLC/DCS data 714 may represent data generated or used by one or more programmable logic controllers or distributed control systems implemented with the at least one processing facility 314. The PLC/DCS data 714 may include both historical and current data generated or used by one or more programmable logic controllers or distributed control systems. In other words, the PLC/DCS data 714 may include previous or historical PLC- or DCS-related data, as well as current PLC- or DCS-related data.

The process-related data also includes laboratory data 716, which refers to data generated within one or more laboratory settings related to the at least one processing facility 314. For example, the laboratory data 716 may include analysis results obtained by manual or automated processing of crop samples taken over time, such as laboratory estimates of the amount of sucrose contained in sugarcane samples. Again, the laboratory data 716 may include both historical and current data generated within one or more laboratory settings. In other words, the laboratory data 716 may include previous or historical laboratory analysis results, as well as current laboratory analysis results.

The process-related data further includes process flow diagram (PFD)/process and instruction diagram (PID) data 718, which refers to diagrams or other data defining how materials like harvested crops are processed within the at least one processing facility 314. For example, the PFD/PID data 718 may identify processing equipment and flows of materials between the processing equipment, such as in the at least one processing facility 314. The process-related data also includes equipment data sheet/specification data 720, which can include data identifying operational characteristics of the processing equipment. For instance, the equipment data sheet/specification data 720 may include maximum or minimum temperatures, pressures, flow rates, or other characteristics of the processing equipment in the at least one processing facility 314. In addition, the process-related data includes economic data 722, which can relate to market data or other economic-related data associated with crops being or to be processed. Example of economic data 722 could include the market price for one or more end products (such as recoverable sucrose or other products from harvested crops), market analyses, or contracts involving the at least one facility 314.

The sub-process 704 represents or includes operations used to pre-process at least some of the raw data that is obtained. In this particular example, the sub-process 704 includes data cleaning operations 724 and 726, which can be used to respectively clean the PLC/DCS data 714 and the laboratory data 716. For example, the data cleaning operations 724 and 726 may include operations used to remove outliers (such as in the manner described above) from the data 714-716, filter or smooth the data 714-716, perform linear interpolation to generate missing or additional data, or otherwise create cleaned data streams.

The sub-process 706 represents or includes operations used to generate one or more machine learning models 728 and one or more material balances 730, which may be associated with at least one facility. For example, the sub-process 706 can involve training one or more machine learning models to predict various characteristics of the at least one processing facility 314 based on the clean data 714-716. As particular examples, the one or more machine learning models can be trained to predict physical characteristics of the processing equipment within the at least one processing facility 314 when processing harvested crops or other materials. These predictions can ideally be used to subsequently identify settings for the processing equipment that may be used to increase or maximize quantities of one or more products that can be generated using the processing equipment. The one or more material balances 730 can be defined based on how materials like harvested crops are processed by the processing equipment and move within the at least one processing facility 314. The one or more material balances 730 can be based on factors like conservation of matter, laws of thermodynamics, and known reaction chemistries involved with the processing equipment.

The sub-process 708 represents or includes operations used to integrate the one or more machine learning models 728 and the one or more material balances 730 in order to generate one or more reconciled machine learning models 732. While the one or more machine learning models 728 may be trained to predict physical characteristics of the processing equipment within the at least one processing facility 314, there are limits to the physical characteristics. For example, temperatures, pressures, and flow rates within or associated with the processing equipment can limit how harvested crops or other materials may actually be processed under realistic operating conditions. The sub-process 708 can be used to retrain the one or more machine learning models 728 based on the one or more material balances 730 so that the one or more reconciled machine learning models 732 generate realistic predictions regarding the processing equipment.

The sub-process 710 represents or includes operations used to combine the one or more reconciled machine learning models 732, the constraints 734, and one or more objective functions 736 into an integrated optimization model 738 that is used to perform optimization. The one or more objective functions 736 can be used to define one or more objectives for controlling the processing equipment in the at least one processing facility 314. At least one of the one or more objectives is typically based on the economic data 722, such as when an objective function 736 is used to increase or maximize the monetary value of the product(s) recovered from the harvested crops or other materials being processed. The integrated optimization model 738 is used during the sub-process 710 to perform optimization based on the one or more objective functions 736.

In some cases, the optimization may occur in two phases 740-742. In the first phase 740, the optimization may use the integrated optimization model 738 to minimize the use of slack variables in the one or more objective functions 736. One or more slack variables can be added to at least one objection function 736 in order to allow for small mismatches between certain constraints and to increase the flexibility of the optimization. These mismatches may be due to a number of factors, such as one or more faulty sensors or other faulty equipment, and the one or more slack variables can be added to an objection function 736 in order to account for these issues. However, it may be undesirable to allow the slack variables to be used in certain ways during optimization, such as when a reconciled machine learning model 732 could use the slack variables to make adjustments that are not actually feasible. Thus, the first phase 740 here may involve minimizing the use of the slack variables in an optimization, which in some cases might be accomplished by penalizing the use of the slack variables in the one or more objective functions 736. In the second phase 742, the integrated optimization model 738 can be used to maximize potential profit associated with the crop harvesting. The second phase 742 here can use the value(s) of the slack variable(s) determined in the first phase 740.

The optimization that is identified using the sub-process 710 here may include (among other things) optimized PLC/DCS data 744, which can represent setpoints or other settings associated with the processing equipment in the at least one processing facility 314. The sub-process 712 represents or includes operations that may be used to optionally project the optimized PLC/DCS data 744 back into the original data stream(s) so as to provide recommendations to subject matter experts or manufacturing operators.

As a particular example application for the process 700, consider process optimization being applied to the processing of raw sugarcane in order to extract sucrose from the raw sugarcane. After sugarcane is harvested, it can enter a processing facility 314 in which it undergoes various processing until ultimately being output as raw sugar, which is almost pure sucrose. There are multiple stages within this processing, often including juice extraction, juice clarification, and syrup clarification, each of which is associated with different processing equipment like crushers, mills, flash tanks, heaters, pans, centrifuges, and more.

The process 700 can be used to maximize sucrose extraction yield, which can be defined as the percentage of sucrose that is recovered in raw sugar. This involves a combination of first principles fundamentals (such as material balances), machine learning linear regression or other machine learning models, and MILP optimization. The process 700 can be used here to combine separate data streams related to sugarcane processing in order to increase sugar recovery. Here, the process 700 can be used to combine data streams from different data sources in order to develop one or more machine learning models 728 and one or more associated reconciled machine learning models 732, physical constraints 734, and economic objectives associated with one or more objective functions 736. These can be combined into an integrated optimization model 738 that predicts sugar yield recovery and physical specifications. Sugar recovery can be improved by optimizing the integrated model 738 subject to the physical constraints and specifications. In some cases, the results can be projected back into the original data stream(s).

Sugar manufacturing (as well as other harvested crop processing and other processes) can utilize dissimilar data streams, such as the data 714-722 described above. Each of these data streams may provide one or more dimensions (but not all dimensions) of knowledge into the underlying process. Integration and coordination of these data streams can allow the underlying process to increase yield, but this integration is challenging because of the disjointed nature of the data. For example, each data set could reside in a different data system and may require expert knowledge to interpret. Moreover, this data is often noisy and incomplete. While subject matter experts might be able to successfully improve production in parts of manufacturing processes using first principle physical relationships and heuristics, integrating all of this data together into a single dataset to take advantage of the multi-dimensional nature of the manufacturing problem is a very complex task. Moreover, since the underlying process is dynamic, experts would continually need to revisit the data to provide updated recommendations so that yield does not degrade over time. Because of this, given scattered datasets and highly-variable processes, manufacturing sites are unable to solve global recovery and optimization problems and instead settle on some localized process improvements using first principles modeling.

Using the techniques of this disclosure, it is possible to perform data aggregation and integration within a single unified data model. For example, to develop an integrated optimization model 738, the following may occur. Historical PLC/DCS data 714 or other historical process data can be cleaned using outlier detection, linear interpolation, data smoothing, or other operations to create a cleaned data stream. Also, historical laboratory data 716 can be cleaned using outlier detection, linear interpolation, data smoothing, or other operations to create a cleaned laboratory data stream. The cleaned data streams can be combined and used to develop one or more machine learning models 728, which can be trained to predict yield and important specifications. For instance, examples of important specifications used in sugarcane processing may include pol, brix, purity, and transmittance of intermediate products (like mixed juice, clarified juice, or syrup) and final sugar and molasses. Often times, feature engineering is used to develop the one or more machine learning models 728. Using the PFD/PID data 718, one or more process material balances can be derived and encoded for various subsystems and sub-processes within at least one processing facility. Using the equipment data sheet/specification data 720, operating constraints can be enumerated for materials (such as pump amps and clarifier capacity) and specifications (transmittance). Using current economic data 722, such as from market analysis or contracts, an economic model of the relative prices of cane feed, chemical additives, electricity, sugar, and molasses or other materials or products can be developed. These operations can be performed to create one or more machine learning models 728, which can perform well across the historical manufacturing data.

To subsequently move into a live production schema, such as one where operators can receive optimization recommendations at regular intervals, the following can be performed. Current PLC/DCS data 714 and laboratory data 716 can be obtained and cleaned to create a live data stream. For each machine learning model 728 and material balance 730, its parameters can be updated based on the live cleaned data stream to produce a reconciled machine learning model 732. At least one slack term can be added to represent current measurement errors to each material balance 730, and the first phase 740 of optimization can be performed to reduce or minimize the slack in the material balance and find a feasible optimization solution that satisfies both the material balances 730 and the reconciled machine learning models 732 with the smallest correcting error. Delta constraints can be defined as shifted actual constraints 734 such that a feasible region for a change in setpoints is the same for both actual sensors used to capture the current PLC/DCS data 714 and “first phase” sensors that include the slack. In some cases, this can be expressed as “Delta Constraint=(Actual Constraint−Actual Sensor)+Phase 1 Sensor.” The second phase 742 of optimization can be performed with material balance slack variables set to their values from the first phase 740, and changes in setpoints can be optimized while satisfying the delta constraints, the material balances 730, and the reconciled machine learning models 732 (with the ultimate objective of increasing or maximizing global sugar or other product recovery). In some cases, recommended setpoints can be defined, such as in the following manner: Recommended Setpoint=(Phase 2 Setpoint−Phase 1 Setpoint)+Actual Setpoint. Note that this recommended setpoint is feasible for the actual constraints 734.

In this way, the one or more reconciled machine learning models 732 can be used to predict important quantities within a production process, which ultimately feed into the global two-stage or other optimization model 738. For instance, the one or more reconciled machine learning models 732 can be developed so that the model(s) 732 can predict physical properties within the at least one processing facility 314. The one or more reconciled machine learning models 732 here can be developed as a substitute for first principles models. Thus, as an example, a model 732 for a mill can predict how sugar is washed out of sugarcane and into juice as the sugarcane is being crushed. Modeling this process with first principles is generally not possible since the physical properties of mill crushers and sugarcane are not measured within the process and would have to be approximated or assumed, negating the predictive power of a model in an optimization. In some cases, the model(s) 732 may allow an optimizer to predict juice pol and brix and bagasse pol and brix, which can be useful or important properties to track in the mill process as they set the material balance of the sugar and solids in the process.

Note that the MILP optimizer used here can accurately represent and simulate a processing facility's interrelated equipment so that setpoint values can be changed in order to maximize sugar extraction or other product generation. In some embodiments, the optimizer's variables and constraints can encode relationships between the equipment's sensor data (such as temperature sensors, pressure sensors, and flow meters) along with analyzer or laboratory-measured data (such as pol and brix measurements). Variables can be well-regulated with specific lower and upper bounds that meet manufacturer and engineering limits as well as usual operating thresholds at a facility 314, which in some cases could be determined by analyzing historical data distributions.

Also note that, in some embodiments, constraints may fall into two classes, such as first principles-based equations and machine learning model-based equations. First principles-based equations may include simple calculations/definitions (such as “Juice Sugar Mass=Juice Mass Flow×Juice Pol/100”) and material balances (such as “Cane Inflow+Water Inflow=Juice Outflow+Bagasse Outflow”). Machine learning model-based equations may include linear regressions (such as “Bagasse Humidity=1.2.×Juice Pol+2.3×Water Inflow+4.2”). Linear regression-based machine learning models can use historical data to make physically-sound predictions that align with first principles understandings. In other words, the machine learning models can reinforce sensical correlations between data, such as “increasing water inflow will always increase bagasse humidity, so it makes sense that the coefficient for that feature has a positive signage within the linear regression equation.”

The reconciled machine learning model(s) 732 here may therefore work hand-in-hand with first principles equations. For example, when an optimizer needs to distribute a specific inflow sum among numerous outflow variables, the reconciled machine learning model(s) 732 can help determine this split. As a particular example, consider a material balance equation “Cane Inflow+Water Inflow=Juice Outflow+Bagasse Outflow” and assume that “Cane Inflow+Water Inflow=200.” In this case, the optimizer may need to know how much of the 200 units needs to go to “Juice Outflow” versus “Bagasse Outflow.” Based on historical data, the reconciled machine learning model(s) 732 may predict a “Juice Outflow” value, and the optimizer can calculate the other flow using the material balance equation. First principles equations alone cannot be used to model the facility here due to (i) the natural degradation of its equipment and (ii) the nonideal nature of the processing. Instead, the reconciled machine learning model(s) 732 can be trained on granular historical data and can more effectively capture how the process truly operates. In addition, various optimizer constraints can depend on real-time sensor and laboratory data to be consolidated via a live data feed. The process 700 integrates and normalizes this data and feeds this data into the optimization formulation as constants. Ultimately, the optimizer's goal (as defined by its objective function(s) 736) can be to maximize overall sucrose extraction yield or other yield(s) across all processes within the facility or facilities 314. Process optimization may apply a phase-by-phase approach across various facility sub-processes like juice extraction, juice clarification, and syrup clarification. Therefore, in some cases, the final objective of overall facility sucrose extraction can be calculated as the multiplicative product of the sequential subprocesses' sucrose extractions.

To summarize, in some embodiments, the MILP optimizer (with its constraints that contain first principles equations and machine learning linear regression models) can manipulate each facility's controllable setpoint values in order to simulate how sucrose extraction varies as a result. The optimizer may ultimately output the most optimal setpoints that will yield the maximum sucrose extraction across the facility or facilities 314.

Although FIG. 7 illustrates one example of a process 700 for using a machine learning-based approach or other approach for generating inputs for an optimizer, various changes may be made to FIG. 7. For example, the process 700 shown in FIG. 7 may occur repeatedly, such as when performed as part of the iterative process 500 shown in FIG. 5. Also, the specific types of data used here are examples only and can vary depending on the implementation.

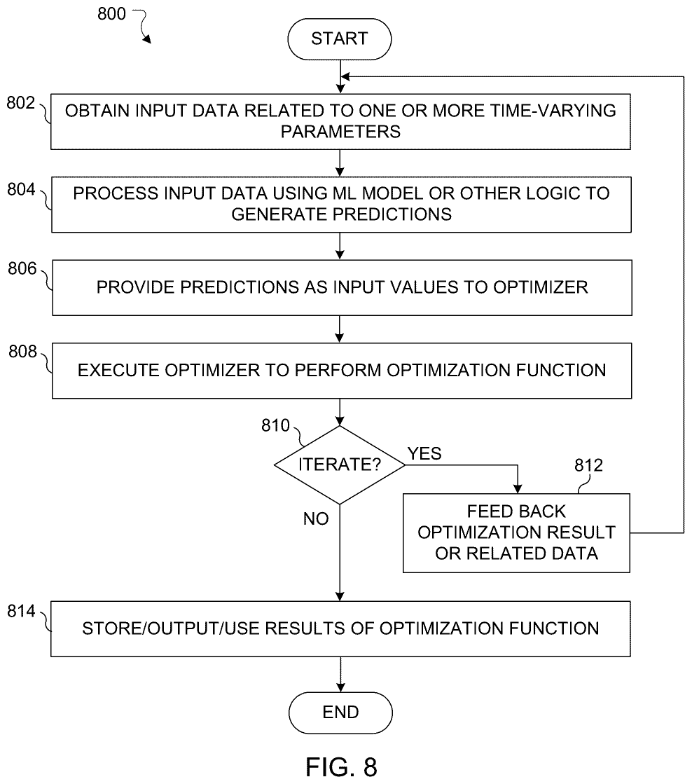

FIG. 8 illustrates an example method 800 for generating inputs for an optimizer using a machine learning-based approach or other approach according to this disclosure. The method 800 may, for example, be performed using a machine learning model or other logic 112 and an optimizer 114 of an application server 106 as described above. However, the method 800 may be performed using any suitable device(s) and in any suitable system(s).

As shown in FIG. 8, input data related to one or more time-varying parameters is obtained at step 802. This may include, for example, the at least one processing device 202 of the application server 106 obtaining inputs 402 related to agriculture harvesting or other operations. The inputs 402 may be obtained from any suitable source(s), such as the database 110 or one or more external systems 118a-118n. In some cases, the inputs 402 may relate to one or more crops being grown in one or more growing areas 302a-302n. In other cases, the inputs 402 may relate to operations that are being performed or that can be performed using equipment in one or more processing facilities 314.

The input data is processed using at least one machine learning model or other logic to generate predictions at step 804. This may include, for example, the at least one processing device 202 of the application server 106 providing the inputs 402 to a machine learning model or other logic 112 in order to generate values for one or more time-varying parameters. In some cases, the one or more time-varying parameters may include one or more parameters related to a quantity of at least one product that can be obtained from crops to be harvested using resources 306. In other cases, the one or more time-varying parameters may include one or more parameters related to a quantity of at least one product that can be obtained from harvested crops using the one or more processing facilities 314. As noted above, the at least one machine learning model or other logic 112 can support any suitable machine learning model architecture, stochastic optimization technique like a simulation-based technique (such as Monte Carlo simulation), reinforcement learning technique, or other approach to generate predictions.

The predictions are provided as inputs to an optimizer at step 806, and the optimizer is executed to perform at least one optimization function at step 808. This may include, for example, the at least one processing device 202 of the application server 106 providing the predictions generated by the machine learning model or other logic 112 to an optimizer 114. This may also include the at least one processing device 202 of the application server 106 executing the optimizer 114 using the predictions (typically along with other data) to generate some type of optimization result, such as by generating an optimization result using an objective function (like Equation (1) above). The type of optimization result generated here can vary depending on the application. For instance, when used for production schedule optimization, the optimization result can represent a schedule for producing one or more materials. As a particular example, the optimization result may represent a schedule for a two-week or other period that assigns resources 306 to harvesting crops from different growing areas 302a-302n or different lots 304 within the growing areas 302a-302n. When used for process optimization, the optimization result can represent one or more setpoints or other parameters that are used to control equipment in at least one processing facility. As a particular example, the optimization result may represent one or more setpoints or other parameters that are used to control equipment in one or more processing facilities 314.

A determination is made whether to iterate the process at step 810. This determination can be made in any suitable manner, such as by determining whether a user has requested or not requested iterative processing or by determining whether a specified amount of processing time has elapsed. If another iteration is to occur, the optimization result and/or data related to the optimization are fed back at step 812. This may include, for example, the at least one processing device 202 of the application server 106 providing the optimization result, the predictions used to generate the optimization result, and/or other data to the machine learning model or other logic 112. This information can be used along with other inputs 402 during a subsequent iteration through this process.

Otherwise, the optimization result is stored, output, or used at step 814. This may include, for example, the at least one processing device 202 of the application server 106 providing a determined harvesting schedule to a user for approval or modification or automatically scheduling harvesting operations using the resources 306. This may alternatively include the at least one processing device 202 of the application server 106 providing a determined process optimization (such as setpoints for processing equipment in the one or more processing facilities 314) to a user for approval or modification or automatically implementing the process optimization within the one or more processing facilities 314.

Although FIG. 8 illustrates one example of a method 800 for generating inputs for an optimizer using a machine learning-based approach or other approach, various changes may be made to FIG. 8. For example, while shown as a series of steps, various steps in FIG. 8 may overlap, occur in parallel, occur in a different order, or occur any number of times (including zero times).

In some embodiments, various functions described in this patent document are implemented or supported by a computer program that is formed from computer readable program code and that is embodied in a computer readable medium. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive (HDD), a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable storage device.

It may be advantageous to set forth definitions of certain words and phrases used throughout this patent document. The terms “application” and “program” refer to one or more computer programs, software components, sets of instructions, procedures, functions, objects, classes, instances, related data, or a portion thereof adapted for implementation in a suitable computer code (including source code, object code, or executable code). The term “communicate,” as well as derivatives thereof, encompasses both direct and indirect communication. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

The description in the present application should not be read as implying that any particular element, step, or function is an essential or critical element that must be included in the claim scope. The scope of patented subject matter is defined only by the allowed claims. Moreover, none of the claims invokes 35 U.S.C. § 112 (f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” “processor,” or “controller” within a claim is understood and intended to refer to structures known to those skilled in the relevant art, as further modified or enhanced by the features of the claims themselves, and is not intended to invoke 35 U.S.C. § 112 (f).

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A method comprising:
obtaining, using at least one processing device, data from one or more data sources, wherein the data is associated with or affects an underlying system to be optimized;
generating, using the at least one processing device, predictions based on the obtained data, wherein the predictions represent estimated values associated with one or more time-varying parameters associated with the underlying system;
providing, using the at least one processing device, the predictions to an optimizer; and
executing, using the at least one processing device, the optimizer to generate optimization results based on the predictions, the optimization results associated with the underlying system.

2. The method of claim 1, wherein executing the optimizer comprises performing optimization using partial knowledge of first principles of the underlying system.

3. The method of claim 1, wherein the optimizer is configured to perform production schedule optimization.

4. The method of claim 3, wherein:
the underlying system comprises an agricultural system in which crops grow in multiple growing areas;
the one or more time-varying parameters relate to one or more products recoverable in the crops; and
the optimization results comprise a schedule identifying resources that are scheduled to perform harvesting of the crops in the growing areas or in lots within the growing areas and when the resources scheduled to perform harvesting of the crops in the growing areas or in the lots within the growing areas.

5. The method of claim 1, wherein:
the underlying system comprises multiple resources whose use is time-varying and that are subject to one or more environmental factors; and
the optimizer determines a scheduling status for use of the resources over time.

6. The method of claim 1, wherein the optimizer is configured to perform process optimization.

7. The method of claim 6, wherein:
the underlying system comprises a processing facility configured to process harvested crops;
the one or more time-varying parameters relate to one or more products recoverable in the harvested crops; and
the optimization results comprise one or more settings for equipment in the processing facility.

8. The method of claim 1, wherein the predictions are generated using a trained machine learning model.

9. The method of claim 8, wherein the trained machine learning model is trained to generate the predictions when the obtained data includes imperfections.

10. The method of claim 1, wherein the predictions are generated using stochastic optimization.

11. The method of claim 10, wherein the predictions are generated using reinforcement learning or Monte Carlo simulations.

12. The method of claim 1, further comprising:
iteratively obtaining the data, generating the predictions, providing the predictions to the optimizer, and executing the optimizer;
wherein at least one of the optimization results or the predictions from one iteration are provided as feedback for use during generation of the predictions during a subsequent iteration.

13. The method of claim 12, wherein:
the predictions are generated using a trained machine learning model; and
the trained machine learning model is configured to use the feedback to compensate for prediction errors associated with the predictions.

14. The method of claim 1, wherein generating the predictions comprises considering uncertainty in an objective function used to generate the predictions.

15. An apparatus comprising:
at least one processing device configured to:
obtain data from one or more data sources, wherein the data is associated with or affects an underlying system to be optimized;
generate predictions based on the obtained data, wherein the predictions represent estimated values associated with one or more time-varying parameters associated with the underlying system;
provide the predictions to an optimizer; and
execute the optimizer to generate optimization results based on the predictions, the optimization results associated with the underlying system.

16. The apparatus of claim 15, wherein, to execute the optimizer, the at least one processing device is configured to perform optimization using partial knowledge of first principles of the underlying system.

17. The apparatus of claim 15, wherein the optimizer is configured to perform production schedule optimization.

18. The apparatus of claim 17, wherein:
the underlying system comprises an agricultural system in which crops grow in multiple growing areas;
the one or more time-varying parameters relate to one or more products recoverable in the crops; and
the optimization results comprise a schedule identifying resources that are scheduled to perform harvesting of the crops in the growing areas or in lots within the growing areas and when the resources scheduled to perform harvesting of the crops in the growing areas or in the lots within the growing areas.

19. The apparatus of claim 15, wherein:
the underlying system comprises multiple resources whose use is time-varying and that are subject to one or more environmental factors; and
the optimizer determines a scheduling status for use of the resources over time.

20. The apparatus of claim 15, wherein the optimizer is configured to perform process optimization.

21. The apparatus of claim 20, wherein:
the underlying system comprises a processing facility configured to process harvested crops;
the one or more time-varying parameters relate to one or more products recoverable in the harvested crops; and
the optimization results comprise one or more settings for equipment in the processing facility.

22. The apparatus of claim 15, wherein the at least one processing device is configured to generate the predictions using a trained machine learning model.

23. The apparatus of claim 22, wherein the trained machine learning model is trained to generate the predictions when the obtained data includes imperfections.

24. The apparatus of claim 15, wherein the at least one processing device is configured to generate the predictions using stochastic optimization.

25. The apparatus of claim 24, wherein the at least one processing device is configured to generate the predictions using reinforcement learning or Monte Carlo simulations.

26. The apparatus of claim 15, wherein the at least one processing device is further configured to:
iteratively obtain the data, generating the predictions, providing the predictions to the optimizer, and executing the optimizer; and
provide at least one of the optimization results or the predictions from one iteration as feedback for use during generation of the predictions during a subsequent iteration.

27. The apparatus of claim 26, wherein:
the at least one processing device is configured to generate the predictions using a trained machine learning model; and
the trained machine learning model is configured to use the feedback to compensate for prediction errors associated with the predictions.

28. The apparatus of claim 15, wherein, to generate the predictions, the at least one processing device is configured to consider uncertainty in an objective function used to generate the predictions.

29. A non-transitory computer readable medium storing computer readable program code that, when executed by one or more processors, causes the one or more processors to:
obtain data from one or more data sources, wherein the data is associated with or affects an underlying system to be optimized;
generate predictions based on the obtained data, wherein the predictions represent estimated values associated with one or more time-varying parameters associated with the underlying system;
provide the predictions to an optimizer; and
execute the optimizer to generate optimization results based on the predictions, the optimization results associated with the underlying system.

30. The non-transitory computer readable medium of claim 29, wherein the computer readable program code that when executed causes the one or more processors to execute the optimizer comprises:
computer readable program code that when executed causes the one or more processors to perform optimization using partial knowledge of first principles of the underlying system.

31. The non-transitory computer readable medium of claim 29, wherein the optimizer is configured to perform production schedule optimization.

32. The non-transitory computer readable medium of claim 31, wherein:
the underlying system comprises an agricultural system in which crops grow in multiple growing areas;
the one or more time-varying parameters relate to one or more products recoverable in the crops; and
the optimization results comprise a schedule identifying resources that are scheduled to perform harvesting of the crops in the growing areas or in lots within the growing areas and when the resources scheduled to perform harvesting of the crops in the growing areas or in the lots within the growing areas.

33. The non-transitory computer readable medium of claim 29, wherein:
the underlying system comprises multiple resources whose use is time-varying and that are subject to one or more environmental factors; and
the optimizer determines a scheduling status for use of the resources over time.

34. The non-transitory computer readable medium of claim 29, wherein the optimizer is configured to perform process optimization.

35. The non-transitory computer readable medium of claim 34, wherein:
the underlying system comprises a processing facility configured to process harvested crops;
the one or more time-varying parameters relate to one or more products recoverable in the harvested crops; and
the optimization results comprise one or more settings for equipment in the processing facility.

36. The non-transitory computer readable medium of claim 29, wherein the computer readable program code when executed causes the one or more processors to generate the predictions using a trained machine learning model.

37. The non-transitory computer readable medium of claim 36, wherein the trained machine learning model is trained to generate the predictions when the obtained data includes imperfections.

38. The non-transitory computer readable medium of claim 29, wherein the computer readable program code when executed causes the one or more processors to generate the predictions using stochastic optimization.

39. The non-transitory computer readable medium of claim 29, wherein the computer readable program code when executed causes the one or more processors to generate the predictions using reinforcement learning or Monte Carlo simulations.

40. The non-transitory computer readable medium of claim 29, further containing computer readable program code that when executed causes the one or more processors to:
iteratively obtain the data, generating the predictions, providing the predictions to the optimizer, and executing the optimizer; and
provide at least one of the optimization results or the predictions from one iteration as feedback for use during generation of the predictions during a subsequent iteration.

41. The non-transitory computer readable medium of claim 40, wherein:
the computer readable program code when executed causes the one or more processors to generate the predictions using a trained machine learning model; and
the trained machine learning model is configured to use the feedback to compensate for prediction errors associated with the predictions.

42. The non-transitory computer readable medium of claim 29, wherein the computer readable program code that when executed causes the one or more processors to generate the predictions comprises:
computer readable program code that when executed causes the one or more processors to consider uncertainty in an objective function used to generate the predictions.
